(19) United States
(12) Patent Application Publication
(10) Pub. No.: US 2017/0037737 A1
(43) Pub. Date: Feb. 9, 2017

(54) ROTATING COMPONENTS WITH BLIND HOLES

(71) Applicant: Rolls-Royce Corporation, Indianapolis, IN (US)

(72) Inventors: Matthew P. Basiletti, Lafayette, IN (US); Rebecca M. Feasel, Whiteland, IN (US)

(21) Appl. No.: 14/819,116

(22) Filed: Aug. 5, 2015

(51) Int. Cl. F01D 5/30; F04D 29/32; F01D 5/02

(52) U.S. Cl. CPC F01D 5/3053; F01D 5/02; F04D 29/322; F05D 2220/32; F05D 2230/10

(57) ABSTRACT

A rotating component used in a gas turbine engine includes a body and a blind hole formed in the body. The blind hole is configured to receive a pin for locating a secondary component relative to the body.

### FIELD OF THE DISCLOSURE

The present disclosure relates generally to gas turbine engines, and more specifically to rotating components of gas turbine engines.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. Left-over products of the combustion are exhausted out of the turbine and may provide thrust in some applications.

Rotating components of gas turbine engines may rotate at high speed. The speed and weight of these components places high stresses on the materials used to form them. Forming features into the components can create areas of localized stress, increasing the likelihood for failure of the components.

### SUMMARY

The present disclosure may comprise one or more of the following features and combinations thereof.

According to the present disclosure, a rotating component for a gas turbine engine may include a body, a pin for positioning a secondary component relative to the body, and a blind hole formed in the body and configured to receive the pin. The blind hole may not penetrate through the body to an opposing free side of the component. The body may be formed from a nickel-based or cobalt-based super alloy. The blind hole may have a substantially cylindrical shaft and a substantially hemispherical floor.

In illustrative embodiments, the shaft may extend into the body and may have a first end defining an opening into the blind hole and a second end spaced apart from the first end. The hemispherical floor may extend into the body from the second end of the shaft.

In illustrative embodiments, the nickel-based or cobalt-based super alloy may be sub-solvus solution heat treated.

In illustrative embodiments, a diameter of the hemispherical floor may be at least 80% and up to 120% as large as large as a diameter of the shaft.

In illustrative embodiments, the diameter of the hemispherical floor may substantially match the diameter of the shaft.

In illustrative embodiments, the diameter of the hemispherical floor may be smaller than the diameter of the shaft such that a step is formed between the hemispherical floor and the shaft.

In illustrative embodiments, the diameter of the shaft may be from about 0.1 inches to about 0.2 inches.

In illustrative embodiments, the diameter of the shaft may be from about 0.1225 inches to about 0.1245 inches.

In illustrative embodiments, the diameter of the hemispherical floor may be from about 0.025 inches greater than to about 0.025 inches less than the diameter of the shaft.

In illustrative embodiments, the diameter of the hemispherical floor may be from about 0 inches to about 0.02 inches less than the diameter of the shaft.

In illustrative embodiments, a depth of the blind hole may be from about 0.19 inches to about 0.21 inches.

In illustrative embodiments, a depth of the blind hole may be from about 0.195 inches to about 0.205 inches.

In illustrative embodiments, the nickel-based or cobalt-based super alloy may be a sub-solvus solution heat treated WASPALOY.

According to the present disclosure, a method of forming a blind hole in a component of a gas turbine engine may include forming a substantially cylindrical shaft into the component and forming a substantially hemispherical floor. The shaft may extend from a first end positioned at an opening at a surface of the component to a second end spaced apart from the first end and into the component. The hemispherical floor may be formed at the second end of the shaft.

In illustrative embodiments, the shaft may be formed with a bevel-tip drill inserted into the component.

In illustrative embodiments, the shaft may be formed with a flat-end mill inserted into the component.

In illustrative embodiments, the hemispherical floor may be formed with a ball-end mill inserted into the component and past the second end of the shaft.

In illustrative embodiments, the ball-end mill may have a smaller diameter than a diameter of the shaft.

In illustrative embodiments, the method may further comprise forming the hemispherical floor using spherical interpolation to move the ball-end mill.

In illustrative embodiments, the component may be formed from a sub-solvus solution heat treated WASPALOY.

These and other features of the present disclosure will become more apparent from the following description of the illustrative embodiments.

### BRIEF DESCRIPTION OF THE DRAWINGS

FIG. 1 is a partial sectional view of a rotating component in a gas turbine engine showing the rotating component is formed to include a blind hole having a substantially cylindrical shaft and a substantially hemispherical floor positioned opposite an opening into the hole and suggesting that the hole is configured to receive a pin used to locate another component of the gas turbine engine relative to the rotating component;

FIG. 2 is a view similar to FIG. 1 showing that the shaft of the blind hole is formed before the hemispherical floor and suggesting that the shaft has one of a planar or conical floor when formed;

FIG. 3 is a view similar to FIG. 2 showing that the hemispherical floor is formed at an end of the shaft and suggesting that the hemispherical floor has a radius substantially matching a radius of the shaft; and

FIG. 4 is a diagrammatic view of one embodiment of a method of forming a blind hole showing that a flat-end mill is used to form the shaft and a ball-end mill is used to form the hemispherical floor.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

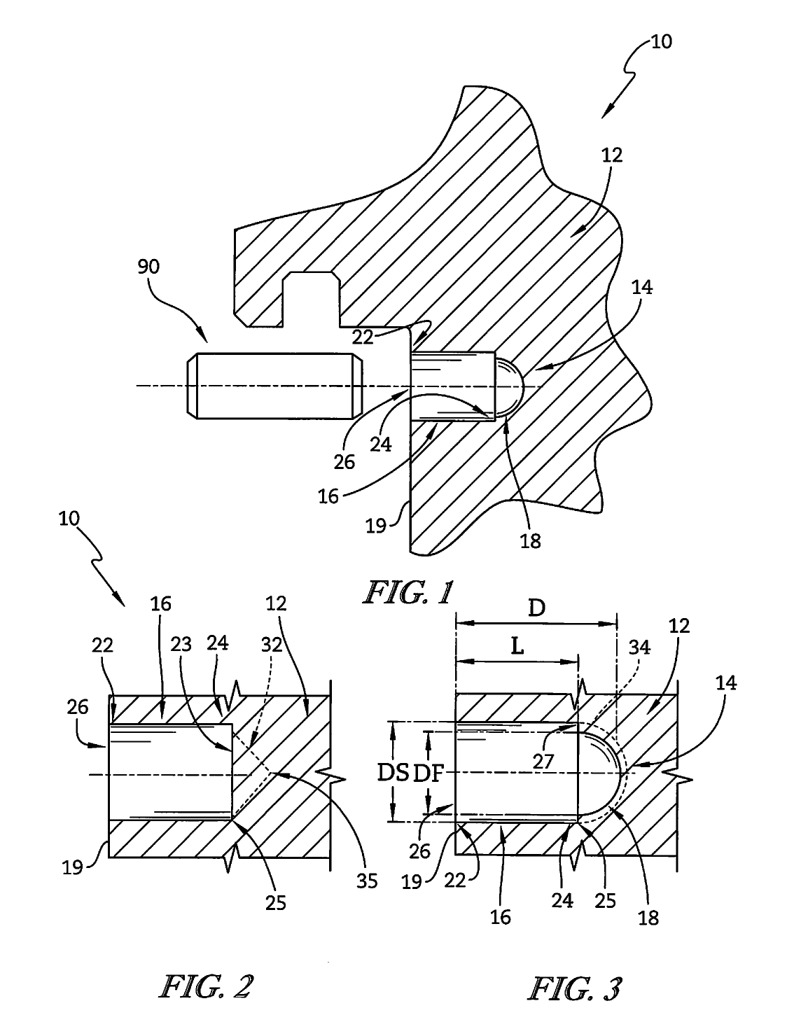

FIG. 1 shows an illustrative rotating component 10 of a gas turbine engine made illustratively from a nickel-based or cobalt-based super alloy. The rotating component 10 includes a body 12 and a blind hole 14 formed in the body 12. The blind hole 14 includes a substantially cylindrical shaft 16 and a substantially hemispherical floor 18. In the illustrative embodiment, the blind hole 14 extends into the body 12 but does not extend through the body 12. In some embodiments, the rotating component 10 includes a plurality of blind holes 14.

In some embodiments, the rotating component 10 is a rotor disk configured to hold blades for rotation about a central axis in a turbine section of the gas turbine engine. In other embodiments, the rotating component 10 is a rotor disk configured to hold blades for rotation about a central axis in a compressor section of the gas turbine engine. However, the blind hole 14 may be formed in other components of the engine.

The shaft 16 extends into the body 12 and includes a first end 22 and a second end 24 spaced apart from the first end 22 as shown in FIG. 1. The first end 22 of the shaft 16 defines an opening 26 into the blind hole 14 at a surface 19 of the body 12. The hemispherical floor 18 extends into the body 12 from the second end 24 of the shaft 16. The hemispherical floor 18 is substantially concentric with the shaft 16.

In the illustrative embodiment, the blind hole 14 is configured to receive a pin 90 as suggested in FIG. 1. In some embodiments, the pin 90 is configured to engage with the blind hole 14 and a secondary component to locate the secondary component relative to the body 12. In some embodiments, the pin 90 is press fit into the blind hole 14. In the illustrative embodiment, the blind hole 14 extends substantially parallel to a central rotational axis of the gas turbine engine. However, in some embodiments, the blind hole 14 extends into the body 12 at an angle relative to the central axis.

The shaft 16 is initially formed to include a substantially planar floor 23 positioned at the second end 24 as shown in FIG. 2. A corner 25 is formed between the planar floor 23 and shaft 16 which can create points of localized stress in the body 12. In some embodiments, a conical floor 32, shown in phantom in FIG. 2, is created depending on the tool used to form the shaft 16. For example, a bevel-tip drill used to form the shaft 16 would also form the conical floor 32. A tip 35 of the conical floor 32 creates an additional point of localized stress.

Points of localized stress may negatively impact the fatigue life of the rotating component 10. These effects may be increased depending on the material used to form the body 12. In some embodiments, the body 12 is formed from a nickel-based or cobalt-based super alloy, such as INCONEL®, HASTELLOY® and other HAYNES® alloys, UDIMET®, or WASPALOY®, for example. In some embodiments, a refined-grain variant of the super alloy is used. For example, in one embodiment, the body 12 is formed from a sub-solvus solution heat treated WASPALOY having a refined grain size. Such a refined-grain WASPALOY has increased notch sensitivity compared to a super-solvus solution heat treated WASPALOY variant and other materials.

Hemispherical floor 18 is formed at the second end 24 of the shaft 16 to minimize the negative effects of the corner 25 and point 35 by distributing stresses along a smooth surface of the hemispherical floor 18. For example, using Finite Element Analysis, the maximum localized stress at point 35 is reduced by forming a hemispherical floor in the blind hole when compared to a blind hole with a conical floor as suggested in Table 1:

TABLE 1

| | Conical Predicted | | Spherical Predicted | | Maximum |
|---|---|---|---|---|---|
| | Stress (ksi) | | Stress (ksi) | | Stress |
| Application | Max | Min | Max | Min | Reduction |
| 1 | 353.44 | 88.81 | 143.22 | 24.35 | 59% |
| 2 | 366 | 100.81 | 144.33 | 26.92 | 61% |

The shaft 16 of the blind hole 14 has a diameter DS and the hemispherical floor 18 has a diameter DF as shown in FIG. 3. In the illustrative embodiment, the diameter DF is at least about, or precisely, 80% as large as the diameter DS as suggested by phantom line 34. A step 27 is formed between the shaft 16 and the hemispherical floor 18 where the diameter DF is smaller than the diameter DS as shown in FIG. 3. In some embodiments, the diameters DS, DF are substantially the same. In some embodiments, the diameter DF is at most about, or precisely, 120% as large as the diameter DS. Localized stress is further reduced the closer in size the diameter DF is to the diameter DS.

In some embodiments, the diameter DS of the shaft 16 is from about, or precisely, 0.1 inches to about, or precisely, 0.2 inches. In some embodiments, the diameter DS of the shaft 16 is from about, or precisely, 0.1225 inches to about, or precisely, 0.1245 inches. In some embodiments, the diameter DF of the hemispherical floor 18 is from about, or precisely, 0.025 inches greater than to about, or precisely, 0.025 inches less than the diameter DS of the shaft 16. In some embodiments, the diameter DF of the hemispherical floor 18 is from about, or precisely, 0 inches to about, or precisely, 0.02 inches less than the diameter DS of the shaft 16.

A depth D of the blind hole 14 is defined by a length L of the shaft 16 and the diameter DF of the hemispherical floor 18 as shown in FIG. 3. In some embodiments, the depth D is from about, or precisely, 0.19 inches to about, or precisely, 0.21 inches. In some embodiments, the depth D is from about, or precisely, 0.195 inches to about, or precisely, 0.205 inches.

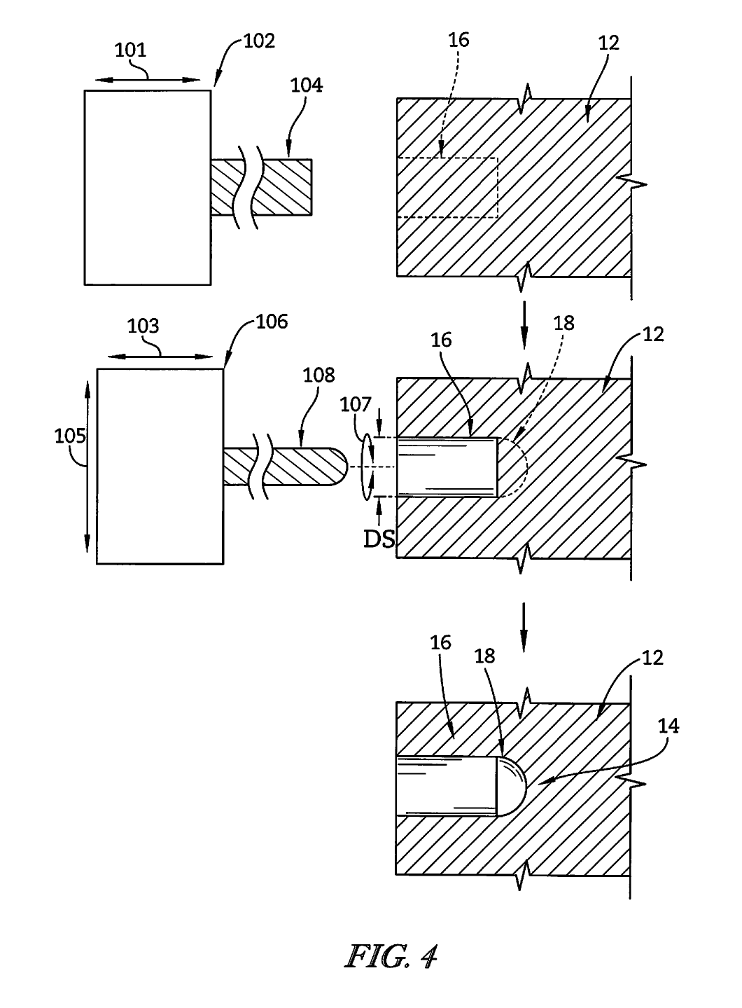

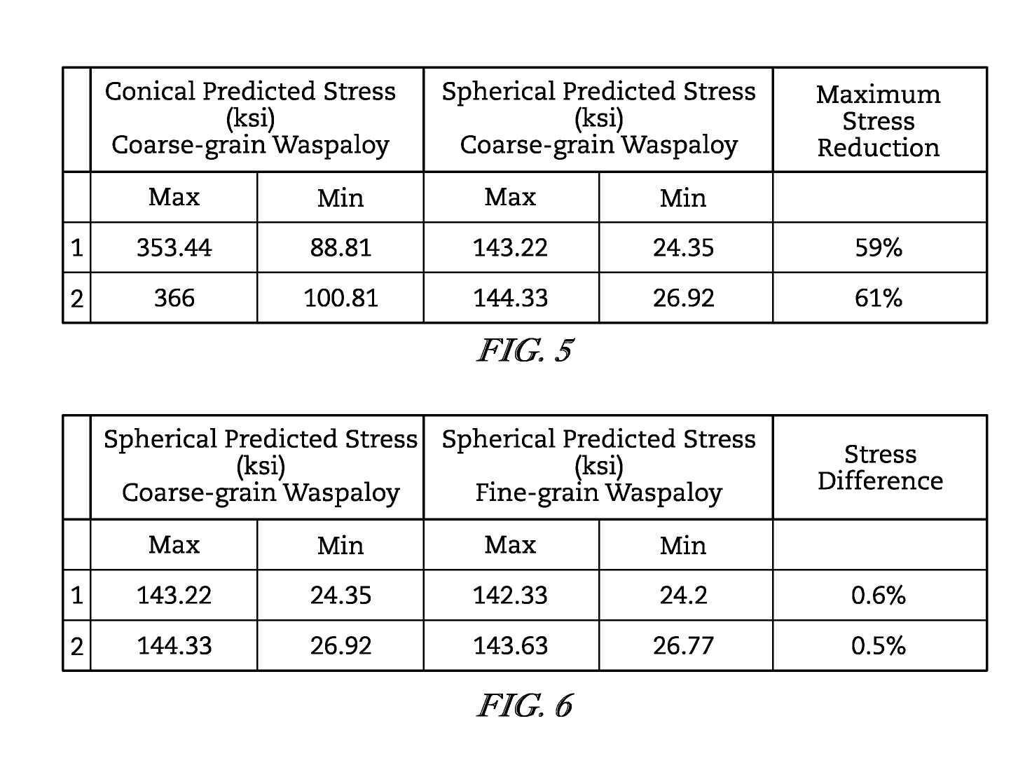

One illustrative embodiment of a method for forming the blind hole 14 is shown in FIG. 4. A milling machine 102 rotates a flat-end mill 104 which is inserted into the body 12 to form the shaft 16 as suggested by arrow 101. In some embodiments, a bevel-tip drill is used in place of the flat-end mill 104 to form the shaft 16. A milling machine 106 rotates a ball-end mill 108 which is used to form the hemispherical floor 18. The milling machine 106 translates the ball-end mill 108 using spherical interpolation as suggested by arrows 103, 105, 107. The milling machine 106 can also translate the ball-end mill 108 in a direction perpendicular to both arrows 103 and 105. In the illustrative embodiment, the ball-end mill 108 has a smaller diameter than the diameter DS of the shaft 16 to allow the ball-end mill 108 to translate within the shaft 16 and form the hemispherical floor 18.

What is claimed is:

1. A rotating component for a gas turbine engine, the rotating component comprising
a body formed from a nickel-based or cobalt-based super alloy,
a pin for positioning a secondary component relative to the body, and
a blind hole formed in the body and configured to receive the pin, the blind hole including a substantially cylindrical shaft and a substantially hemispherical floor,
wherein the shaft extends into the body and includes a first end defining an opening into the blind hole and a second end spaced apart from the first end, and the hemispherical floor extends into the body from the second end of the shaft.

2. The rotating component of claim 1, wherein the nickel-based or cobalt-based super alloy is sub-solvus solution heat treated.

3. The rotating component of claim 1, wherein a diameter of the hemispherical floor is at least 80% as large as a diameter of the shaft and up to 120% as large as the diameter of the shaft.

4. The rotating component of claim 3, wherein the diameter of the hemispherical floor substantially matches the diameter of the shaft.

5. The rotating component of claim 3, wherein the diameter of the hemispherical floor is smaller or larger than the diameter of the shaft such that a step is formed between the hemispherical floor and the shaft.

6. The rotating component of claim 3, wherein the diameter of the shaft is from about 0.1 inches to about 0.2 inches.

7. The rotating component of claim 6, wherein the diameter of the shaft is from about 0.1225 inches to about 0.1245 inches.

8. The rotating component of claim 7, wherein the diameter of the hemispherical floor is from about 0.025 inches greater than to about 0.025 inches less than the diameter of the shaft.

9. The rotating component of claim 8, wherein the diameter of the hemispherical floor is from about 0 inches to about 0.02 inches less than the diameter of the shaft.

10. The rotating component of claim 9, wherein a depth of the blind hole is from about 0.19 inches to about 0.21 inches.

11. The rotating component of claim 10, wherein a depth of the blind hole is from about 0.195 inches to about 0.205 inches.

12. The rotating component of claim 2, wherein the nickel-based or cobalt-based super alloy is a sub-solvus solution heat treated WASPALOY.

13. A method of forming a blind hole in a component of a gas turbine engine, the method comprising
forming a substantially cylindrical shaft into the component, the shaft extending from a first end positioned at an opening at a surface of the component to a second end spaced apart from the first end and into the component, and
forming a substantially hemispherical floor at the second end of the shaft.

14. The method of claim 13, wherein the shaft is formed with a bevel-tip drill inserted into the component.

15. The method of claim 13, wherein the shaft is formed with a flat-end mill inserted into the component.

16. The method of claim 15, wherein the hemispherical floor is formed with a ball-end mill inserted into the component and past the second end of the shaft.

17. The method of claim 16, wherein the ball-end mill has a smaller diameter than a diameter of the shaft.

18. The method of claim 17, further comprising forming the hemispherical floor using spherical interpolation to move the ball-end mill.

19. The method of claim 18, wherein the component is formed from a sub-solvus solution heat treated WASPALOY.
